(19) United States
(12) Patent Application Publication
(10) Pub. No.: US 2005/0206109 A1
(43) Pub. Date: Sep. 22, 2005

(54) Sport board

(76) Inventor: Paul T. Mash, Mt. Clemens, MI (US)

Correspondence Address: Arnold S. Weintraub;The Weintraub Group, Suite 240, 32000 Northwestern Highway, Farmington Hills, MI, 48334, US

(21) Appl. No.: 10/988,035

(22) Filed: Nov. 13, 2004

Related U.S. Application Data
(63) Continuation-in-part of application No. 10/310,170, filed on Dec. 4, 2002, now Pat. No. 6,834,881.
(60) Provisional application No. 60/338,772, filed on Dec. 4, 2001.

(51) Int. Cl. B62M 1/00

(52) U.S. Cl. 280/87.042

(57) ABSTRACT

A sport board and a shock absorption system therefor, includes a glide board used in snow and aquatic sports or a roller or skate board, a rocker platform mounted in a seesaw fashion atop the sport board, whereupon opposite ends of the rocker platform may alternately move towards and away from the sport board, and a shock absorbing cushion disposed in respective spaces formed between the forward end portions and the rearward end portions of the sport board and platform. The cushions inhibit rocking of the rocker platform, absorb impact, and create a cushion sufficient for the rider to exert extreme pressures for balance, control, and maneuvers on any given terrain conditions. As a skate board, the board is curvilinear, including a center section that is spring-like and downwardly concave opposed end sections that are upwardly concave, and roller assemblies are proximate the opposite ends or end sections. The board includes shock absorbing bumpers.

### CROSS-REFERENCE TO RELATED APPLICATIONS

This is a continuation-in-part patent application of co-pending U.S. patent application Ser. No. 10/310,170 filed Dec. 4, 2002, which is a Completion Application of co-pending of U.S. Provisional Patent Application Ser. No. 60/338,772, filed Dec. 4, 2001, the entire disclosures of each incorporated herein by reference.

### BACKGROUND OF THE INVENTION

1. Field of the Invention

The present invention pertains to an improved design for a sport board, such as exemplified by a skate board, kite board, snow board, snow skate board, ski board, sail board, wave board, snow skis, and like sports and leisure related boards. More particularly, the present invention concerns a shock absorbing system for a gliding type sport board and roller type skate board.

2. Prior Art

In recent years, board-related sport including land sports such as snowboarding, skate boarding, and water or aquatic sports have continued to become increasingly popular sports. These sports have also become more competitive and demanding on both the rider and the equipment. The demand continues in these recreational and competitive land and water sports.

In any form of transportation, there is an inherent element of “shock” that is produced by changing terrain conditions that transfers energy from the terrain ground or water into the vehicle that is speeding across it. In most forms of transportation, the vehicle has been equipped with some form of “shock absorbers” to smooth out the ride and to increase performance of both the equipment and the rider. It has become essential for the vehicle to be equipped with shock absorbers especially in vehicles like snowboards, skateboards, water skis and wakeboards. The present invention, as subsequently detailed, addresses this issue.

### SUMMARY OF THE INVENTION

In accordance herewith, there is provided a shock absorbing system for a dual binding sport board which comprises:
a dual binding sport or sporting board, and a rocker system associated therewith.

The rocker system or rocker, generally, comprises a pair of spaced apart first and second or lower and upper, respectively, rocking members which are disposed transverse to the longitudinal access of the board. The rocking members are hingedly interconnected through suitable means to enable the rocker to rotate or pivot forward and aft.

The first or lower rocking member is integral with or otherwise affixed to the board on the upper surface thereof.

The upper or second rocking member is affixed to a platform which is disposed above the board such that a space is created between the bottom of the platform and the upper surface of the board.

The upper rocking member and the lower rocking member include means for interdigitating, such as spacers or hinge members which cooperate to define a hinge. A hinge pin, or the like, interconnects the two together and defines a pivot about which the platform rotates.

In a first embodiment here, a pair of bladders or other compressible bodies are affixed to the upper surface of the board, one on each side of the hinge, in the space between the board and the platform. Thus, as the platform teeters or pivots between a forward and an aft position on the board, it will encounter one of the two bladders. Each bladder is inflatable and contains the same amount of fluid, such as air.

The bladders and hinge may be encased within a sealed shroud or the like to protect it from the elements.

It is further contemplated in the practice of the present invention that the present invention be part of an original equipment or that it be retrofitted wherein the bladders, rocker members, and platform are disposed on a mounting plate which is secured to a sports board.

According to an important aspect of this invention there is provided a dual binding roller or skate board, said board comprising:
a lower platform having a center section, a forward end section, and a rearward end section,
a first and a second roller assembly for rollably supporting the platform on the ground, said assemblies secured, respectively, to the forward and rearward end sections of said platform,
a rocker platform having a center section, a forward end section, and a rearward end section,
a hinge for hingedly connecting the center sections together, wherein the forward and rearward end sections alternately move towards and away from one another, and wherein a first and second space is defined between the platforms and on opposite sides of the hinge connection, and
a first and a second compressible member disposed, respectively, in said first space and said second space, said compressible members resisting movement of the end sections towards one another.

The platforms are generally oblong, have a central longitudinal axis, parallel lateral sides extending longitudinally, and top and bottom surfaces. When hingedly connected, the forward and rearward end sections and lateral sides are generally in juxtaposed relation with one another.

In a skate board, as in the first described gliding board, the compressible member may be an air bladder, a compressible body of foam, or compressible body of a suitable elastomeric material, such as rubber. The compressible member may be affixed to the upper surface of the lower platform. Thus, as the rocker platform teeters or pivots between a forward and an aft position above the lower platform or board, the forward or rearward end section thereof, depending on the direction of rotation, will move toward and encounter one of the two compressible members, which member will elastically compress and absorb shock.

According to an important feature of the present invention, the lower platform forms a compound curve wherein the center section is concave down, so as to form a resilient bow-like or spring structure between the roller assemblies that absorbs and distributes vertical landing loads, and the front and rear end sections are concave up. The upper platform is generally planar and the front and rear end sections are concave up.

Additionally, according to another important feature, shock absorbing bumpers are provided on the curled up forward and rearward ends of the rocker platform.

In all other respects, such as the hinged connection, bladder securement, retrofitting, interconnection, and the like are the same as that described for the gliding sport board.

For a more complete understanding of the present invention, references made to the following detailed description and accompanying drawings. In the drawings, like reference characters refer to like parts throughout the several views in which:

### BRIEF DESCRIPTION OF THE DRAWINGS

FIG. 1 is a top view of a sports board for use in the present invention;

FIG. 2 is a side view of a sports board having the rocker system hereof mounted thereto;

FIG. 3 is a top view of a sports board having the lower rocker member mounted thereto;

FIG. 4 is a bottom review of the platform used herein having the upper rocker member mounted thereonto;

FIG. 5 is a partial side view showing the platform and the hinge pinhole;

FIG. 6 is a plan view, partly exploded, showing the hinge pin and the air bladders used herein;

FIG. 7 is a perspective view of a sleeve;

FIG. 8 depicts the rubber outer containment housing or shroud with upper and lower rubber seals and valve ports;

FIG. 9 is a front view of the upper and lower rocker members;

FIG. 9A is a front view of a spacer;

FIG. 10 is a side view of an air bladder;

FIG. 11 is a side view of a second embodiment hereof;

FIG. 12 is a top plan view of a skate board according to the present invention;

FIG. 13 is a side elevation view of the skate board of FIG. 12 having the rocker system hereof; and

FIG. 14 is a broken elevational view of an alternate hinge assembly.

### DETAILED DESCRIPTION OF THE PREFERRED EMBODIMENT

According to the present invention, and with reference to the drawings, there are depicted leisure related gliding and roller boards used in various ground and aquatic sports, the boards being provided with a shock absorbing system. Depending on the sport, these boards are called a ski board, skate board, wake board, water board, water ski(s), kite board, snow board, sail board, wave board, snow ski(s), and ski, and comprise a category of sporting equipment having a platform upon which a rider stands or kneels with both feet, the platform having a strong, resilient, flexible and substantially flat structure conventionally made of one or materials including wood, plastic and fiber glass or carbon fiber. The present invention is contemplated for use in connection with and conjointly with any one of such dual footing boards.

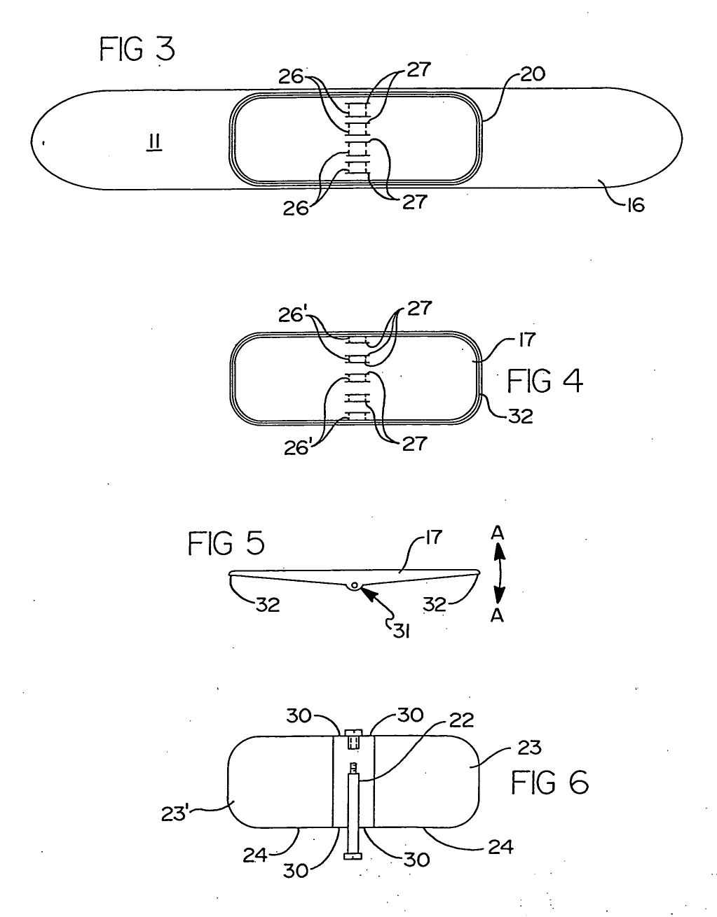

In FIGS. 1-10, a first embodiment according to this invention comprises a gliding type sports board, generally denoted at 16. The board 16 is referred to as a snowboard and is for illustrative purposes only. That is, the present invention is applicable to any other type of board such as those alluded to hereinabove.

The board or sports board 16 hereof has an upper surface 11 and a lower surface 13. Disposed on the board 16 is a shock absorbing system or shock absorber defined by a rocker system or rocker, generally, denoted at 12 (FIG. 9).

The rocker system hereof, generally, comprises:
a first or lower rocker member 19 which is disposed atop the board 16, and
an upper or second rocker member 31 which interdigitates with and is hingedly connected to the lower rocker member via means for hingedly interconnecting such as a pin or hinge pin 22.

In a first embodiment hereof, the lower rocker is secured to the upper surface 11 of the board 16 by any suitable means and, preferably, is molded integrally with the board. The lower rocker 19, generally, comprises a transverse body disposed on the upper surface 11 of the board 16 and extending across the width thereof. The lower rocker member 19 further includes:
a pair of spaced apart flanges 19′, 19″, each having an aperture formed therein, and
a plurality of cylindrical sleeves 26 which are mounted onto the transverse rocker or fulcrum 19 or is integrally formed therewith.

The sleeves 26, as noted, are cylindrical and have a hollow interior. The sleeves are co-axial with themselves and the apertures of the flanges. A plurality of spacers 27, as shown in FIG. 9A are disposed on either side of associated sleeves 26, as shown.

Disposed on either side of the fulcrum are compressible members 23 and 23′. Each compressible member is similar. The compressible members 23 and 23′ can comprise any suitable article such as a section of compressible foam, an inflatable bladder, or the like. Each of the bladders is independently inflatable with a suitable fluid such as water, air or the like. A valve member 24 associated with each bladder may be used to inflate and deflate its associated bladder, as desired. Preferably, in the practice of the present invention, each of the bladders contains the same amount of fluid so that they are substantially equal. Preferably, the bladders are air bladders. Optimally, the bladders or compressible members are toroidal although other shapes can be used.

The compressible members are secured to the upper surface of the board by any suitable means such as through an anchor 30. Alternatively, the bladders may be secured to the upper surface 11 with a nylon hook and fastener (Velcro), gluing, or the like. Alternatively, air pressure, alone, within the compressible members may be used to retain the compressible members to the upper surface of the board by sandwiching the members between the board and the platform.

As shown, a first sealing element or rim seal 20 is circumferentially disposed about the lower rocker member 19. The rim seal 20 is used to attach a lower portion of a shroud 33 to encase the lower rocker 19 and to protect it from the elements, as explained herein below. The rim seal 20 secures a lower seal 28 associated with the shroud 33 thereto. Sealing is accomplished by snap-fitting the lower seal 28 into the lower rim seal 20.

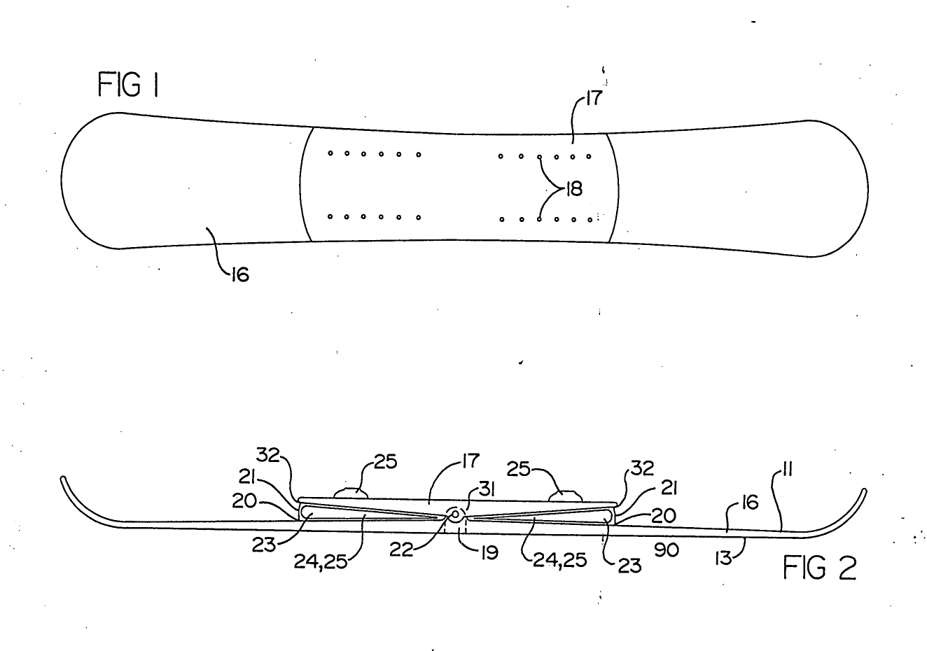

As noted, the upper rocker assembly 31 is constructed similar to rocker member 19 and includes aperture flanges 31′ and 31″. The member 31 is secured to a platform 17. The platform 17 has an upper surface 17′ and a lower surface 17″. As shown, the rocker 31 is integral with or otherwise affixed to the lower surface 17″. As shown in FIG. 5, the lower surface 17″ of the platform 17 is substantially bisected by the transverse rocker or fulcrum member 31 into a pair of identical sections. As shown in FIGS. 2 and 5, the bottom surface 17″ of the platform 17 tapers from the member 31 to the outer perimetral edge of the board. The taper permits the space 90 between the lower surface of the platform 17 and the upper surface 11 of the board 16 to reduce quickly when the platform and the board teeter into each other.

The upper rocker member 31 also includes a plurality of co-axial cylindrical sleeves 26′ integral therewith. The sleeves 26′ are constructed similarly to the sleeves disposed on the lower rocker member 19 and are spaced in a manner such that they will interdigitate, therewith, as shown in FIG. 9. The sleeves 26′ may be integrally formed with the fulcrum member 31 or may comprise a plurality of sleeves mounted thereonto. It should be noted in this regard, that the sleeves formed in the lower fulcrum member or transverse fulcrum member 16 may be integrally molded therewith, as shown in FIG. 9. Since each of the sleeves are coaxial, the hinge pin 22 can project therethrough to hingedly interconnect the platform to the lower rocker.

It is readily appreciated that the platform pivots about the pin 22 both fore and aft in the directions of the arrow A (FIG. 5).

It should be noted that the intermediate sleeves 26 and 26′ are optional since it is only necessary that the upper fulcrum member 31 be hingedly connected to the lower rocker member 19 so that the hinge pin 22 may project therethrough and interconnect the upper rocker to the lower rocker. Thus, only the apertured flanges 9′, 9″, 31′ and 31″ are necessary for hinged interconnection. Optionally, a plurality of wear rings or spacers 27 may be disposed between the sleeves 26′ to prevent wear or the like.

Alternatively, and as shown in FIG. 14, the interdigitating hinge members may be elliptical in shape having a width slightly greater than the pivot pin 22 thereby creating a vertical slot 70. This enables the pin to be vertically axially moveable in the slot. The elliptical slot enables the upper board to thus move up and down to further cushion the ride.

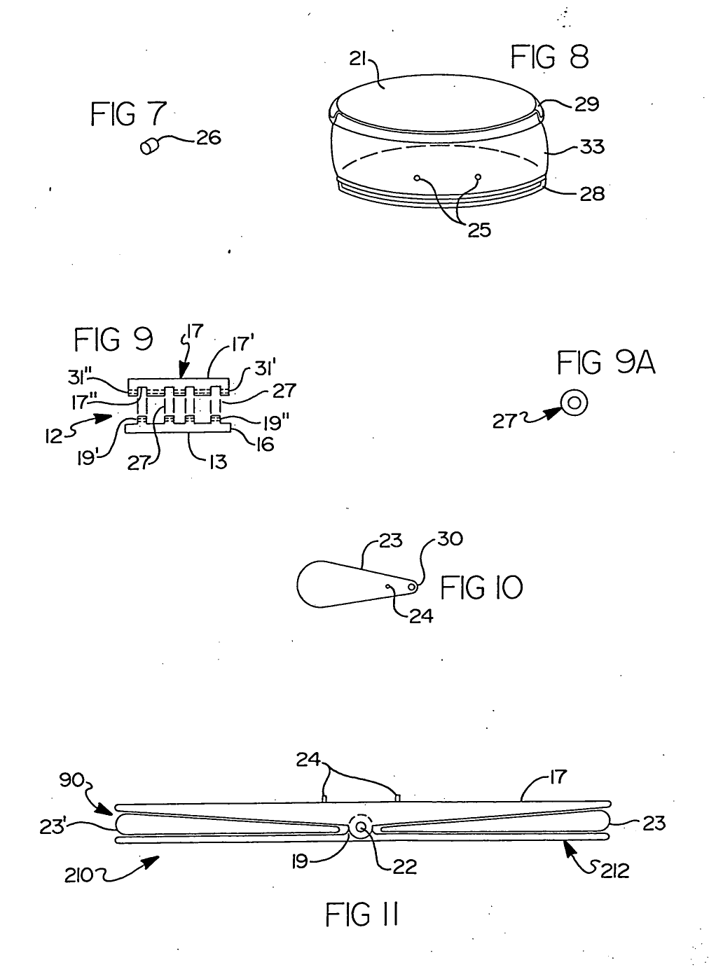

As shown in FIGS. 5 and 8, secured to the lower surface of the platform and surrounding the upper rocker member is a rim seal 32. The rim seal 32 slidingly fits into the lower rim seal 28 to effectively close off the rocker system from the elements. The shroud 33 carries the seals 28 and 29.

In order to maintain the rocker system sealed off from the elements and to maintain the integrity and pressure within the bladders, valve ports 25 are provided in the seal or shroud 33. The valves 24 extend from each of the bladders and protrude through the ports 25 to enable them to be connected to a suitable source of compressed air or other fluid (not shown). A pressure gauge or the like (not shown) can be operatively affixed to the valves to measure and control the pressures within the bladders.

When the outer containment housing or shroud 33 is placed around the rocker assembly, the upper seal 29 and the lower seal 28 are snapped into the upper rim seal 32 and the lower rim seal 20, respectively, to form a seal that will protect all the components inside from water, snow, ice, etc. The outer containment housing is a continuous piece made of rubber or other suitable material. The outer containment housing includes a bead that snaps into the rim seals all the way around the shock absorbing assembly to protect it from the elements. The shroud 33, being attached at both its top and bottom, has a sufficient extension capability to allow full range of motion of the most forward part and most aft part of the platform.

It should be noted that the shroud is not essential to the practice of the present invention. When not present, the valves extend, preferably, from the compressible members and project therefrom to a suitable accessible place, such as through the platform, as shown and discussed with reference to FIG. 11 hereinbelow.

With the board and the platform joined together, there is defined a unitary shock absorbing assembly. The board and the platform are free moving parts, able to teeter in opposite directions from one another.

The user, when deploying the present invention as a snowboard is positioned on the platform, toes pointing to one lateral edge, and heals pointing to the other or opposite lateral edge, one foot forward of the fulcrum, and one foot aft of the fulcrum, and the feet at about a 3°-35° angle to the length and the width of the platform. Although not shown, the platform may be modified to accommodate bindings, footwear or the like.

When used as water ski, the user has one foot forward of the fulcrum, centered on the platform and toes pointing toward the tip of the board and the other foot centered on the platform after of the fulcrum and toes pointing toward the tip of the board.

As a wakeboard, the user is in the standing position; as a kneeboard, the user is in the kneeling position.

The present invention can be used to retrofit an existing sport board. Thus, and shown in FIG. 11 and in a second embodiment hereof, generally, denoted at 210 there is provided a mounting plate 212 to which is secured the rocker system hereof. The mounting plate 212 is dimensioned to lie atop or be superposed a sport board (not shown). The mounting plate is secured to the sport board through any suitable means, such as threaded fasteners, adhesives, and the like. In all respects the shock absorbing system is the same as in the first embodiment.

It is to be appreciated that there has been described herein a sports board which enables the user to ride on a “cushion of air” or other suitable fluid thereby softening the ride while at the same time providing a “teeter-totter” effect.

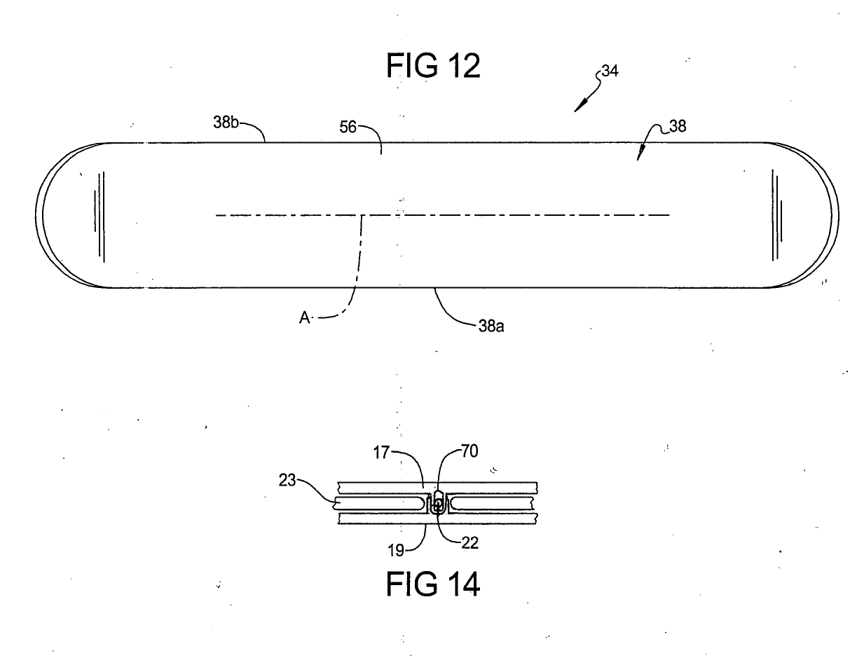

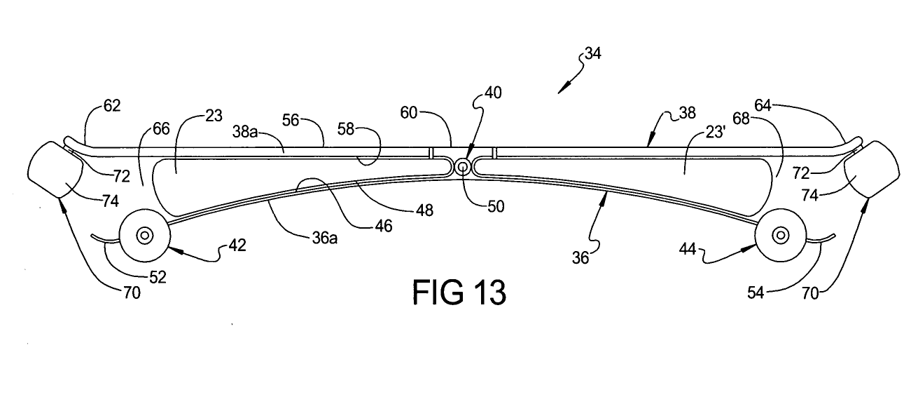

Turning to FIGS. 12-13, a second embodiment according to this invention comprises a rolling board 34 which is used in various ground-based sports. The board 34 is referred to as a “skate board” and is for illustrative purposes only.

The rolling or skate board 34 comprises a board or lower platform 36, an upper board or rocker platform 38, a hinge arrangement 40 for connecting the rocker platform 38 to the lower platform 36, and two pairs of rollers or wheels 42 and 44 connected to the lower platform 36. The lower platform or board 36 is generally oblong shaped, viewed in plan, symmetrically centered about a longitudinal axis “A”, has parallel lateral sides 36a and 36b, a top surface 46, a bottom surface 48, and a compound curve shape. That is, the lower platform 36 is curvilinear from end to end and is concave down relative to the center or midsection 50 of the platform and concave up at the forward and rearward end sections 52 and 54. The compound curvature forms a resilient bow-like or spring structure between the roller assemblies 42 and 44 that absorbs and distributes vertical landing loads, strengthens the board, and gives the rider more control of the board.

The upper rocker platform 38 is generally planar and defines a “deck” upon which the rider stands in using the skateboard 34 herein. The rocker platform 38 is generally a “mirror image” of the lower platform 36 and is generally oblong shaped, viewed in plan, symmetrically centered about a longitudinal axis “A”, has parallel lateral sides 38a and 38b, a top surface 56, a bottom surface 58, a center section 60, and concave up front and rear end sections 62 and 64.

The platforms may be comprised of wood, aluminum, fiberglass, plastic or carbon fiber, and made by pressing together various layers of these materials, depending on the desired degree of stiffness or flexibility desired. The actual materials and method of constructing the skate board to provide the desired combination of toughness, elasticity, feel and response are known in the art.

The hinge arrangement 40 connects the center sections 50 and 60 of the platforms 36 and 38 together such that the rocker platform 38 is atop the lower platform 38 and the forward and rearward end sections 62 and 64 of the rocker platform 38 move alternately up and down towards and away from the forward and rearward end sections 52 and 54 of the lower platform 36. That is, the upper rocker platform 38 is connected in a “seesaw” manner to the lower platform 36.

The hinge arrangement 40 forms a fulcrum, as described hereinabove, and includes the interdigitating hinge or rocker members 19 and 31 and the pivot pin 22 for interconnecting the hinge members together, the hinge member 19 being centrally connected to the lower platform 36 and projecting upwardly from the upper surface 46 thereof and the hinge member 31 being centrally connected to the upper rocker platform 38 and projecting downwardly from the bottom surface 56 thereof. The hinge arrangement 40 enables the upper rocker plate 38 to pivot and the opposite ends thereof to move up and down in a see-saw manner relative to the lower platform 36.

The wheels 42 and 44 are connected to the lower platform 36 adjacent to the front and rear end sections 52 and 54 by what are referred to as “trucks”, or like known expedients known in the art, wherein to allow the board 34 to turn. The wheels 42 and 44 are preferably made of tough polyurethane plastic, having a durometer of about 85 (soft) and 97 (hard), and sized between 39 and 66 millimeters in diameter. The connection and wheel materials are conventional and will not be described further as known by those skilled in the art.

As shown in FIG. 13, when interconnected, the platforms 36 and 38 define a first channel or space 66 that extends between the fulcrum 40 and the forward end sections 52 and 62 and a second channel or space 68 that extends between the fulcrum 40 and the rearward end sections 54 and 64.

Preferably and according to this invention, the roller or skate board 34 is provided with an arrangement for absorbing shock arising from use. In a manner as described hereinabove, the compressible members 23 and 23′, respectively, are disposed in the channels or spaces 66 and 68. The compressible members 23 and 23′ are generally coextensive with and extend between the opposite lateral sides of the respective platforms 36 and 38 and extend between the pivot arrangement 40 and the concave forward and rearward end sections of the respective platforms 36 and 38.

As described hereinabove, the compressible member 23 and 23′ may comprise a section of compressible foam, a section of elastomeric material, such as a rubber, or an inflatable bladder which may be toroidal or other convenient shape. In the case of the bladder, each bladder is independently inflatable with a suitable fluid such as water, or a suitable gas, such as air and the like. The pressure inside the bladders is set at a pressure (psig) desired by the rider, sufficient for the rider to exert extreme forces for balance, control, and maneuvers on any given terrain conditions.

To further absorb shock, a pair of bumpers 70 are mounted on the rocker platform 38, each bumper including a mounting pin 72 and a body 74 of elastomeric material, such as rubber. As shown in FIG. 12, one bumper is mounted to the curled concave up front end section 62 and the other bumper is mounted to the curled concave up rearward end section 64. Each bumper mounting pin 72 is generally centered on the longitudinal axis, perpendicular to its respective end section 62 and 64 and directed forwardly and downwardly towards the curled concave up forward and rearward ends sections 52 and 54 of the lower platform 36. The bumpers 70 are protective devices provided to absorb impact shocks or impede contact in a collision.

Although not shown in the drawing, it is possible to affix and emplace bumpers within the ring defined by the toroidal compressible members to limit the downward movement of the upper member in any of the boards hereof.

Furthermore, it is important to note that the sport boards defined herein are of the type where both of the user's feet are disposed thereon. Thus, each board accommodates a pair of feet, dual bindings, etc. What is critical to note is that, in use, both feet of the user are placed on the board. Also, the dual foot board hereof, when used, is stable and enables better banking and cutting.

Having, thus, described the invention

1. A sport board, comprising:
a lower platform having a center section, a forward end section, and a rearward end section,
a pair of roller assemblies secured to said platform for rollably supporting the platform on the ground, one roller assembly being secured to the forward end section and the other roller assembly being secured to the rearward end section,
an upper rocker platform having a center section, a forward end section, and a rearward end section,
a hinge for hingedly connecting the center sections together, wherein the forward and rearward end sections alternately move in a direction towards and away from one another, and wherein a first and second space is defined between the platforms and on opposite sides of the hinge connection, and
a first and a second compressible member disposed, respectively, in said first space and said second space, said compressible members resisting movement of the end sections towards one another, wherein the board is a dual binding board.

2. The board as claimed in claim 1, wherein the board is a roller or skate board, and wherein said platforms have a central longitudinal axis, parallel lateral sides extending longitudinally, and top and bottom surfaces, and further wherein the forward and rearward end sections and lateral sides are generally in juxtaposed relation with one another when the platforms are connected to one another.

3. The roller or skate board as claimed in claim 2, wherein the compressible member comprises an air bladder.

4. The roller or skate board as claimed in claim 2, wherein, the compressible member comprises a body of compressible foam.

5. The roller or skate board as claimed in claim 2, wherein the compressible member comprises a body of suitable elastomeric material.

6. The roller or skate board as claimed in claim 2, wherein said lower platform is in the shape of a compound curve, the center section of said curve being concave down, wherein to form a resilient bow-like or spring structure between the roller assemblies that absorbs and distributes vertical landing loads, and the front and rear end sections are concave up.

7. The roller or skate board as claimed in claim 2, further comprising a first and a second bumper of elastomeric material, said bumpers being connected, respectively, to the forward and rearward end section of said rocker platform wherein to project forwardly and rearwardly from the skate board and cushion impact forces.

8. The roller or skate board as claimed in claim 2, wherein said lower platform is formed from layers of material selected from the group consisting of wood, aluminum, fiberglass, plastic, and carbon fiber.

9. The roller or skate board as claimed in claim 2, wherein said rollers are made of polyurethane plastic, having a durometer measurement of between 85 and 97.

10. In a shock absorbing system for a sports board, of the type for mounting a pair of spaced apart bindings, said skate board including a platform having forward and rearward end sections, and a roller assembly proximate to each end section for rollably supporting the skate board on the ground, an improved shock absorber system comprising:
a rocker platform, said rocker platform having a top surface for supporting a rider, a bottom surface, and concave up forward and rearward end sections, a hinge element for hingedly interconnecting the rocker platform atop the sports board and defining first and second spaces on the opposite sides of the hinge element that extend between the hinge element and the respective forward and rearward end sections of the rocker platform and skate board, the respective forward and rearward end sections being movable towards and away from one another, and
a pair of toroidal compressible members, one said compressible member being disposed in said first space and the other said compressible member being disposed in said second space.

11. The improvement of claim 10, wherein
said board is oblong in shape, has a longitudinal axis, and parallel lateral sides extending longitudinally,
said rocker platform is oblong in shape, has a longitudinal axis and parallel lateral sides extending longitudinally, and
said hinge element comprises a first hinge member affixed to the center section of said skate board, a second hinge member affixed to the center section of said rocker platform, each said hinge member comprising a set of cylindrical elements that are spaced apart a sufficient distance to permit the cylindrical elements of the hinge members to interdigitate with one another and form a continuous cylindrical passage extending along an axis transverse to the longitudinal axis, and a pin in said passage for connecting the hinge members together and the rocker platform to the skate board.

12. The improvement of claim 10, wherein each of the compressible members comprises an inflatable air bladder.

13. The improvement of claim 10, wherein each of the compressible members comprises a compressible foam.

14. The improvement of claim 10, wherein each of the compressible members comprises a compressible elastomeric material.

15. The improvement of claim 10, wherein:
the board is a skate board, said skate board is in the shape of a compound curve, the center section of said curve being concave down, wherein to form a resilient bow-like or spring structure between the roller assemblies that absorbs and distributes vertical landing loads, and said forward and rearward end sections are concave up.

16. The improvement of claim 15, further comprising a first and a second bumper of elastomeric material, said bumpers being connected, respectively, to the forward and rearward end section of said rocker platform wherein to project forwardly and rearwardly from the skate board and cushion impact forces.

17. A skate board, said skate board comprising:
(a) a deck, the deck accommodates a pair of spaced apart bindings,
(b) a lower platform, said platform being oblong in shape, having a longitudinal axis, a pair of parallel lateral sides extending longitudinally, a top surface, a bottom surface, a concave down central section, and concave up forward and rearward end sections,
(c) a forward and a rearward roller assembly, the roller assemblies for supporting the skate board for rolling movement on the ground and secured proximate to said forward and rearward end sections,
(d) a rocker platform, said rocker platform being oblong in shape, having a longitudinal axis, a pair of parallel lateral sides extending longitudinally, a top surface, a bottom surface, a planar central section for supporting a rider, and concave up forward and rearward end sections,
(e) a hinge member, said hinge connecting the center section of said rocker platform to said lower platform and defining a fulcrum in which the forward end sections may alternately move towards and away from one another as the rearward end sections move away and towards one another, a first space being defined between the forward end portions of the aforesaid platforms and a second space being defined between the rearward end portions of the aforesaid platforms,
(f) a first and a second compressible member, the first compressible member being fixedly disposed in the first space and the second compressible member being fixedly disposed in the second space, the compressible members being engaged by and resisting movement of the respective towards one another, and
(g) a first and a second bumper for absorbing and cushioning the skate board from shock arising from impact, the bumpers being fixedly mounted to and extending longitudinally forward and rearward away from the forward and rearward end sections of the rocker platform, each bumper comprised of an elastomeric material.

18. The sport board of claim 1, wherein the compressible members are each toroidal air bladders.

19. The sport board of claim 18 which further comprises:
a first and second bumper for cushioning the board, the bumpers being secured to the lower platform within the open central portion of the toroidal air bladders.
